(19) United States
(12) Patent Application Publication
(10) Pub. No.: US 2013/0056474 A1
(43) Pub. Date: Mar. 7, 2013

(54) Energy Saver Cooking Pot

(71) Applicant: Afzal Chaudhry, Piscataway, NJ (US)

(72) Inventor: Afzal Chaudhry, Piscataway, NJ (US)

(21) Appl. No.: 13/592,315

(22) Filed: Aug. 22, 2012

Related U.S. Application Data
(60) Provisional application No. 61/460,769, filed on Sep. 4, 2011.

(51) Int. Cl. A47J 27/00

(52) U.S. Cl. 220/573.1

(57) ABSTRACT

In every day cooking some heat energy is lost from the outer surfaces of the cooking pot and the pot cover by convection and radiation processes. A major part of this energy can be saved from leaving the cooking pot by heat insulation of the outer surfaces of the cooking pot and the cooking pot cover. This can be achieved by building a double walled cooking pot and a double walled pot cover with highly polished inner surfaces of the walls of the cooking pot and the pot cover and by producing vacuum in the spaces between the walls. The use of such Energy Saver Cooking Pots can not only bring down the energy bill of a household but can also speed up the cooking process.

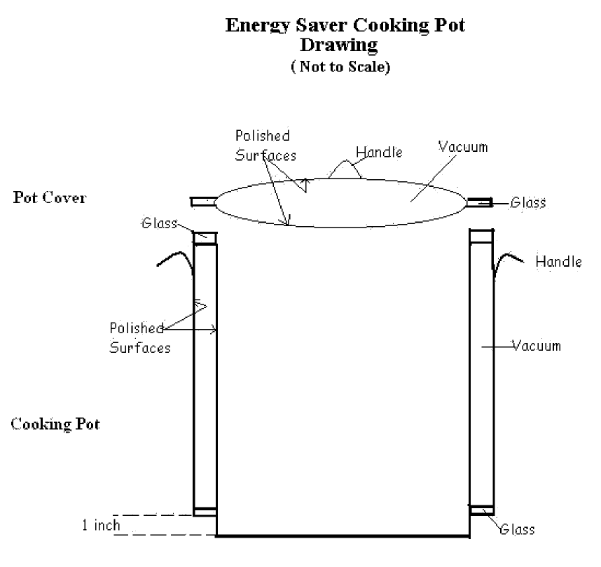

### CROSS REFERENCE TO RELATED APPLICATION

I have already filed a provisional application for this invention. The application number is 61/460,769 and the filing date is Sep. 4, 2011.

### BACKGROUND OF THE INVENTION

Heat energy is lost in every day cooking from the cooking pot by convection and radiation processes. This energy can be saved by heat insulation of the outer surfaces of the cooking pot and the pot cover.

### DESCRIPTION OF THE INVENTION

The Energy Saver Cooking Pot consists of a double walled cooking pot and a double walled cooking pot cover and these walls are insulated from each other. The inner surfaces of the walls of the cooking pot and the pot cover are highly polished to minimize the heat lost by radiation and vacuum is produced in the spaces between the walls to reduce the heat lost by convection.

### DESCRIPTION OF THE DRAWING

The drawing included in the application shows a cross sectional view of an Energy Saver Cooking Pot which can be made of any size and capacity. The cooking pot has a cylindrical metal cover which has a diameter one inch larger and a length 1 inch shorter than the cooking pot and is strong enough to withstand vacuum. The outer surface of the cooking pot and the inner surface of the outer cylinder are highly polished. Using metal glass seals the outer cylinder is joined to the cooking pot and vacuum is produced in the space between the outer cylinder and the cooking pot.

The cover of the cooking pot consists of two strong metal pieces which have highly polished inside surfaces and are joined together by metal glass seals. Vacuum is produced in the space between the two pieces of the cover. Handles are also welded to the cooking pot and the cover.

Claim—In every day cooking energy can be saved by using the Energy Saver Cooking Pot.

I make the claim:

1. In every day cooking, energy can be saved by using the Energy Saver Cooking Pot.
